(19) United States
(12) Patent Application Publication
(10) Pub. No.: US 2004/0006448 A1
(43) Pub. Date: Jan. 8, 2004

(54) Apparatus and method for pipeline inspection

(76) Inventor: G. Gregory Penza, Huntington, NY (US)

Correspondence Address: BROOKS KUSHMAN P.C., 1000 TOWN CENTER, TWENTY-SECOND FLOOR, SOUTHFIELD, MI, 48075, US

(21) Appl. No.: 10/187,676

(22) Filed: Jul. 2, 2002

(51) Int. Cl. G06F 15/00

(52) U.S. Cl. 702/183

(57) ABSTRACT

An inspection apparatus for inspecting the interior of a live gas pipeline includes an entry tube for attaching the apparatus to a valve in the pipeline. A guide pole is sealingly attached to the entry tube, and linearly and rotatably articulates within the tube. Attached to an end of the guide pole is a camera module, mounted to an articulation mechanism. The end of the guide pole is moved into position within the interior of the pipeline, and the camera module sends video image signals to a remote output device, such as a monitor or recorder. A high intensity, adjustable light source is provided to illuminate the interior of the pipeline. An electronic control unit allows an inspector to remotely manipulate the camera module and light source to provide image data from various locations within the interior of the pipeline.

### BACKGROUND OF THE INVENTION

1. Field of the Invention

The present invention relates to a pipeline inspection apparatus capable of use in a live gas main, and a method of using the apparatus.

2. Background Art

For more than 30 years, video inspection has been a baseline fundamental analytical tool for the evaluation and assessment of pipeline integrity. Originally developed as an aid for sewer system maintenance, video inspection equipment and techniques have played a key role in the development of “no-dig” and “trenchless” pipeline rehabilitation methods. This is because the choice of the best trenchless rehabilitation method, for any given application, is often largely based on the video inspection that takes place prior to the rehabilitation. Thus, the information gleaned from the pre-rehabilitation video inspection is used as the basis for key decisions that drive the entire rehabilitation process.

The inspection of pipes often falls into two broad categories: inspections performed for purposes of preventative maintenance, and inspections performed as a response to a need for repair maintenance. The former category may include such things as locating cracks in the pipeline prior to their reaching a critical length, discovering the location of unknown branches or service tees, determining the exact location of valves and fittings, and finding water within the pipeline. In general, video inspection equipment is useful as a proactive tool for assessing the cleanliness, corrosion, and structural integrity of the pipeline. In the case of repair maintenance, high quality video inspection data is also very important. Indeed, the very nature of repair maintenance is such that it may include responding to emergency situations, particularly where hazardous materials are involved. Thus, the importance of quality video inspection equipment and techniques is further underscored.

Because of the paramount importance of video inspection in pipeline rehabilitation applications, a myriad of inspection devices and methods have been developed to try to provide the information required to formulate a sound rehabilitation strategy. For example, U.S. Pat. No. 5,754,220 (the '220 patent) describes a portable inspection device for inspecting the interior of a pipe or sewer line. The inspection device includes a battery operated camera connected to a long coaxial cable. The cable is wound into a cable storage drum, which is also operated by the battery. As the cable is unwound from the storage drum, an inspector feeds the cable further into the pipeline, thereby moving the camera to inspect different portions of the pipeline. High intensity light emitting diodes provide the necessary light within the pipe for the camera to gather the desired images.

Despite its ability to provide some inspection data, the device described in the '220 patent has a number of limitations. For example, a large quantity of cable is necessary if the camera is to traverse a long pipe. Despite providing a rotating drum for coiling and uncoiling the cable, which may reduce some of the burden of handling the cable, the shear bulk of the cable (and drum) increases the size of the inspection device and necessarily makes it more difficult to transport. In addition, the '220 device has limited applicability. Specifically, it is intended for use in sewer pipes or other unpressurized pipelines. The '220 device makes no provision for using the inspection device in a pressurized pipeline, for example, in a live gas main.

One attempt to provide an inspection device for use in a pressurized vessel is described in U.S. Pat. No. 5,604,532 (the '532 patent), which discloses an apparatus for providing images of the inside of a pressurized vessel such as a railway tankcar. The apparatus includes a camera module attached to a flex pipe that is configured to be inserted into the tankcar. The camera module has a 60° diagonal focus, adjustable from 6″ to 20′. The flex pipe is mated to a control pipe, which itself is disposed within a “reach pipe”. A securing ring seals the interface between the reach pipe and the control pipe, and also contains a plurality of loops, configured to accept counterbalancing weights. The weights may be necessary in applications where the pressure inside the tankcar exceeds 30 psi.

The '532 patent describes manual manipulation of the camera for both pan (rotation) and tilt angle. In order to rotate the camera, the '532 apparatus requires an operator to manually rotate the reach pipe, which causes rotation of the control pipe, and thus the camera. Tilting the angle of the camera is also a manual operation, accomplished by pushing the control pipe and flex pipe downward into the tankcar. As the operator pushes the control pipe (and therefore the flex pipe) into the tankcar, a tie-back strap attached to the camera housing prohibits downward movement of the camera. As the control pipe and flex pipe continue to travel downward, the flex pipe bends, causing the camera to tilt. Such a system allows the camera to tilt through about 130°.

Although the '532 apparatus is designed to function in a pressurized environment, it is not adequate for inspections of live gas mains. First, tankcars and other pressurized vessels are relatively short compared to gas mains, which may traverse hundreds of feet between points of entry. Hence, there is a need for an apparatus capable of capturing images at remote distances from the camera module. This not only requires a camera equipped with powerful zoom capabilities, but also requires a high intensity light source to illuminate the remote regions of the pipeline. Moreover, the camera should be easy to articulate so that it can capture images from any point within its viewing distance.

Another limitation of the '532 apparatus is the need to use unwieldy counterbalance weights when working with pressures over 30 psi. Gas distribution lines may have pressures of 125 psi., and gas transmission lines may operate at 500 psi. or more. Thus, having to use weights to offset pipeline pressure is not a satisfactory solution. Moreover, working on high pressure gas pipelines necessarily includes some inherent risk. Therefore, the ability to remotely manipulate the camera position is important when an operator is inspecting high pressure distribution or transmission lines.

Thus, there exists a need for an apparatus specifically designed to provide video inspection data from within a live gas main. Because of this longstanding need, the gas distribution industry has been largely unable to realize the full benefit of trenchless technology. This is because trenchless rehabilitation requires a high-resolution video inspection to provide the data necessary to make informed decisions and to formulate the rehabilitation strategy. Gathering this data typically involves decommissioning the gas main, which then makes it possible to use one of the more conventional inspection devices. Decommissioning a gas main is not a satisfactory solution, as it may be impracticable, and even if possible, it is usually undesirable.

Accordingly, it is desirable to provide a video inspection apparatus for use in a live gas main that outputs high resolution images, eliminates the large quantity of bulky cable necessary for conventional pipeline inspection devices, and provides image data from remote locations within the pipeline, without the need to move the camera in close proximity to those locations.

### SUMMARY OF THE INVENTION

The present invention provides an inspection apparatus for inspecting the interior of a live gas main. The apparatus is configured to attach to a valve, in particular a valve used with a pipeline tapping mechanism. Once the apparatus is attached and sealed to the valve, the valve is opened to allow a camera module access to the interior of the gas main. A high intensity fiber optic light illuminates the interior of the pipeline while the camera module captures images and relays the information back to an output and/or recording device. The camera module and fiber optic light are attached to a motor-driven articulation mechanism which allows an operator to remotely manipulate them to record image data from any point within the camera's imaging range. The camera module is configured with optical and digital zoom features to enhance the quality of the images, and to increase the imaging range of the camera.

### BRIEF DESCRIPTION OF THE DRAWINGS

FIG. 1 shows a partially schematic representation of a portion of an inspection apparatus in accordance with the present invention, part of the inspection apparatus being disposed in a pipeline;

FIG. 2 shows a partially schematic representation of the inspection apparatus shown in FIG. 1; and

FIG. 3 shows a partially schematic representation of a portion of an inspection apparatus in accordance with an alternative embodiment of the present invention.

### DETAILED DESCRIPTION OF THE PREFERRED EMBODIMENT(S)

One aspect of the present invention provides a video inspection apparatus for use in live gas mains.

Another aspect of the invention provides an inspection apparatus including a camera module that outputs high resolution images of remote locations within a pipeline, without moving the camera module in close proximity to object or objects being imaged.

A further aspect of the invention provides an inspection apparatus that includes a motor driven articulation mechanism for the camera module.

Accordingly, an apparatus for inspecting a pressurized pipeline having an access structure attached thereto is provided. The access structure selectively allows access to an interior of the pipeline. The apparatus comprises an attachment structure, a portion of which defines an interior space. The attachment structure is configured for attachment to the access structure of the pipeline. A guide pole having a pole axis is at least partially disposed within the interior space of the attachment structure, and is movable relative to the attachment structure. A sealing mechanism is provided for sealingly attaching the guide pole to the attachment structure. An articulation mechanism is attached to a first end of the guide pole, and a camera module is attached to the articulation mechanism. The camera module is configured to pass through the access structure and into the pipeline interior. The apparatus also includes a light source configured to illuminate the interior of the pipeline, and an electronic control unit for at least controlling the articulation mechanism and the camera module.

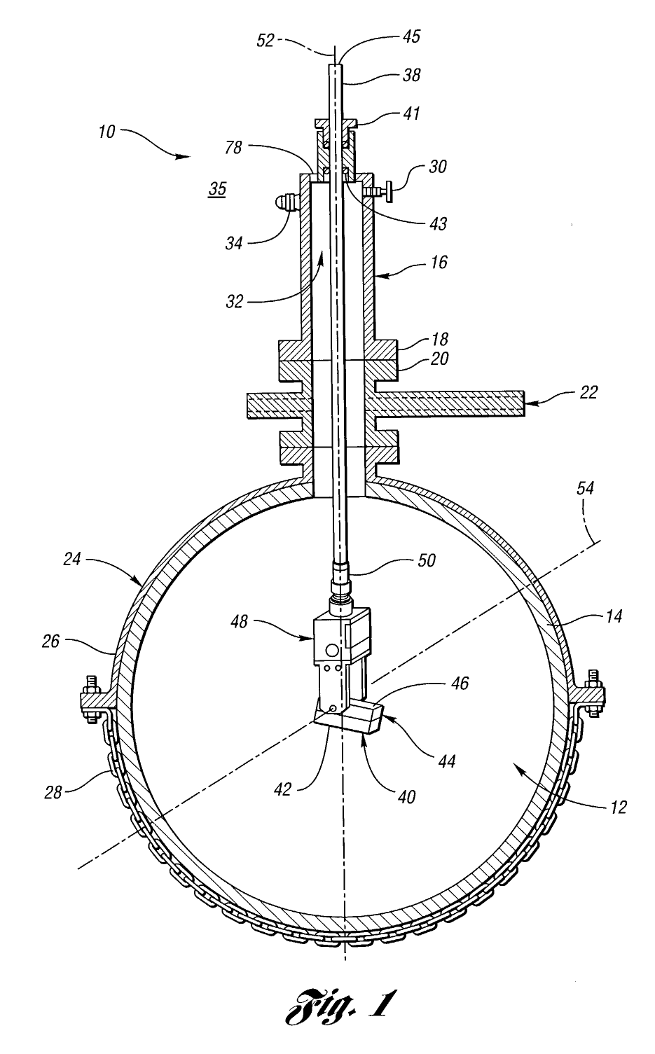

FIG. 1 shows an inspection apparatus 10 used to inspect an interior 12 of a pipeline 14. The inspection apparatus 10 includes an attachment structure, which in this embodiment is an entry tube 16. The entry tube 16 includes a flange 18 which attaches to a mating flange 20 on a first valve 22. As illustrated in FIG. 1, the first valve 22 caps a pipeline tapping mechanism 24, that includes a saddle 26 and a chain 28. A pipeline tapping mechanism such as 24 is typically used to gain access to a pipeline at a location where no valve was originally installed. The first valve 22, is merely one type of access structure that allows access to the interior 12 of the pipeline 14. A valve, often a gate or iris valve, is commonly used as an access structure when a pipeline is pressurized. In the case of a non-pressurized pipeline, such as a sewer line, a simple hub may suffice as an access structure. When a pipeline has a hub, or other non-flanged access structures, the entry tube 16 can be appropriately configured to mate with the access structure.

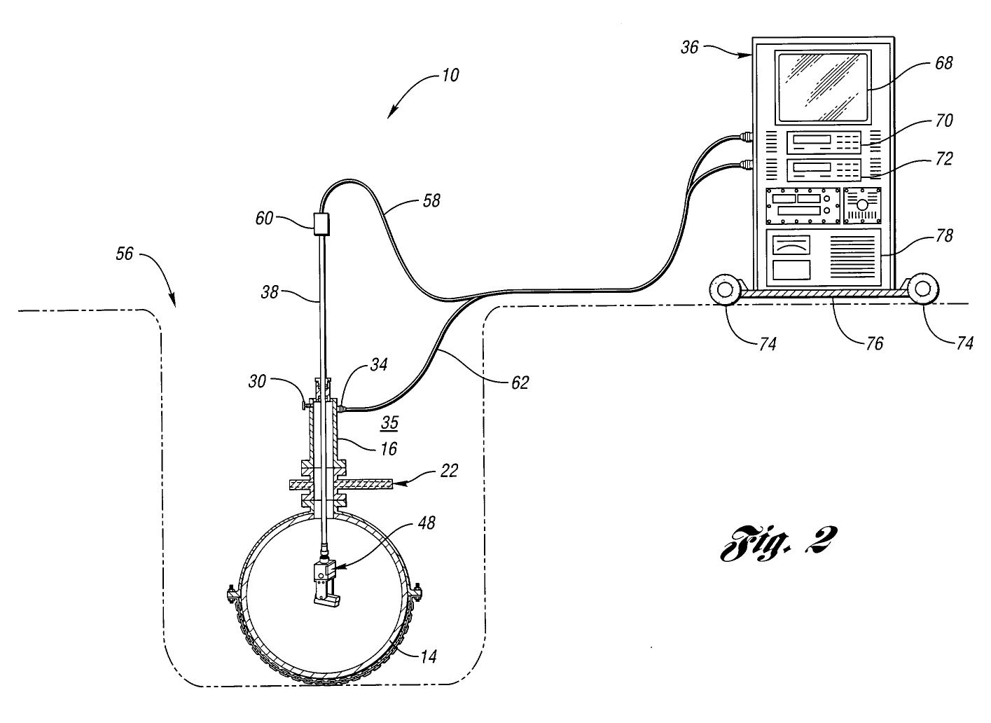

Attached to the entry tube 16 is a second valve, in this case a stopcock 30. The stopcock 30 is particularly useful when the inspection apparatus 10 is used to inspect live gas mains such as the pipeline 14. This is because the stopcock 30 allows for the removal of oxygen from within an interior space 32 of the entry tube 16. This helps to ensure that oxygen will not mix with the gas within the pipeline 14, which could create a combustible and potentially hazardous mixture. Also attached to the entry tube 16 is a sensor 34 for detecting the presence of oxygen and/or other gases. Specifically, the sensor 34 can be configured to detect the presence oxygen within the interior space 32 of the entry tube 16, to help ensure that all of the oxygen has been bled off through the stopcock 30. In addition, the sensor 34 can also be configured to detect the presence of gas in an environment 35 surrounding the entry tube 16. This helps to ensure that no gas from the interior 12 of the pipeline 14 is escaping into the atmosphere during the inspection operation. The sensor 34 is connected to an electronic control unit 36 (see FIG. 2), which monitors the output of the sensor 34. The control unit 36 can be configured such that when oxygen or gas is detected, the operator is alerted, or alternatively, the power to the inspection apparatus 10 is automatically cutoff.

The inspection apparatus 10 also includes a guide pole 38 that is used to lower a camera module 40 into the interior 12 of the pipeline 14. A packing gland 41 is used to seal the entry tube interior space 32 from the environment 35. A second seal 43 can be used inside the entry tube 16, to provide additional assurance that gas from the pipeline 14 will remain in the entry tube 16. Both the packing gland 41 and the second seal 43 are configured to allow the guide pole 38 to move relative to the entry tube 16 without compromising the seal. The guide pole 38 in this embodiment is an anodized aluminum tube, approximately 1½ inches in diameter. The use of other materials and tube sizes is contemplated, as the present invention can be configured to accommodate the requirements of many different applications. For example, the guide pole 38 can be made in different lengths to allow the camera module 40 to be easily lowered into small diameter pipelines, or inserted deep within a large gas main, which may be 48 inches or more in diameter. Since the guide pole 38 is a tube, it has an interior portion 45 through which electrical wires may be run.

Because the camera module 40 may be used in a pressurized and/or wet environment, the use of a camera housing 42 is contemplated. Though shown schematically in FIG. 1, it is understood that the camera housing 42 can be made from any material, and in any configuration, that will protect the camera module 40 from the environment in the pipeline interior 12. For example, in one embodiment, the camera housing 42 is generally a rectangular, six-sided case with one removable side, and is made from anodized aluminum having a clear polymeric lens inserted therein. The camera module 40 is placed within the camera housing 42, and the removable side is attached with a seal to isolate the camera module 40 from the environment inside the pipeline 14. To facilitate the electrical connections, a standard bulkhead connector is used on the camera housing 42.

The camera module 40 includes a camera and a zoom lens that allows an operator to remotely capture images from the pipeline interior 12. Though various types of cameras can be used with the present invention, a charged couple device (CCD) video camera facilitates the capturing of sequential digital images. Use of a video camera is not required, but may provide the operator with information not readily gleaned from still photographs. Moreover, use of a CCD camera provides flexibility to the operator, since digital images are easily stored on, and transferred from, digital devices such as computers. In addition, use of a CCD camera also allows the operator to easily slow the frame rate of the image capture, thus allowing a maximum amount of light into the lens. As an alternative, an analog video camera may be used, and the images stored on video tape.

The camera module 40 provides both optical and digital zoom capabilities. A zoom lens attached to the camera provides the optical zoom, while the digital zoom is a function of the CCD camera itself. The combination of the optical and digital zoom allows for the capturing of highly detailed images of the pipeline interior 12, and also allows images to be captured at a great distance from the camera's point of entry into the pipeline 14—e.g., 100 feet or more from the first valve 22. Thus, once the camera module 40 is inserted vertically through the first valve 22, it need not be fed horizontally into the pipeline 14 to capture the desired images.

Adjacent to the camera module 40 is a fiber optic light 44. The fiber optic light 44, illustrated schematically in FIG. 1, is also enclosed in a housing 46 to protect it from the environment inside the pipeline 14. Though other types of light sources can be used with the present invention, a fiber optic light provides certain advantages. First, the source of ignition can be remotely maintained to further ensure safe operating conditions when live gas mains are inspected. The control unit 36 can control a high intensity xenon light source located at or near the control unit itself. The generated light then travels through glass fibers to provide a significant source of light within the pipeline interior 12. In addition, a collimating lens may be attached to the fiber optic light 44 to focus the light as it leaves the glass fibers. Thus, the camera is able to capture clear images in an otherwise unlit environment. To further extend the image capturing capabilities of the camera module 40, an infra red light source may be provided. The infra red light source can be configured to automatically activate whenever the camera attempts to capture images in less than adequate ambient light, or it may be manually controlled by an operator.

In order to manipulate the camera module 40 within the pipeline interior 12, an articulation mechanism 48 is provided. The articulation mechanism 48 is attached to a first end 50 of the guide pole 38. In this embodiment, the articulation mechanism 48 is configured to rotate around a guide pole axis 52. This rotation is referred to as “pan”, and the articulation mechanism 48 is configured to allow a 360 degree pan about the guide pole axis 52. In addition, the articulation mechanism 48 provides 180 degrees of tilt-i.e., rotation about an axis 54 that is perpendicular to the guide pole axis 52. The pan and tilt capabilities of the articulation mechanism 48 allow an operator to manipulate the camera module 40 to capture images from any point within its viewing distance. Although the articulation mechanism 48 is configured for 360 degrees of pan and 180 degrees of tilt, other configurations are contemplated. For example, the articulation mechanism 48 may rotate about more than two axes, or may have different rotational limits—e.g., 360 degrees of rotation for both pan and tilt. The articulation mechanism 48 is rotated by two motors (not shown), that may use belts with optional clutches, or other power transfer mechanisms to rotate the camera module 40. Alternatively, the motors may be directly connected to the camera module 40.

Turning to FIG. 2, the inspection apparatus 10 is seen attached to the pipeline 14, inside a trench 56. The guide pole 38 has a wiring harness 58 extending from a second end 60 and terminating at the control unit 36. Similarly, a second wiring harness 62 is attached to the sensor 34 and also terminates at the control unit 36. The control unit 36 is configured to receive a signal from the sensor 34, and if oxygen is detected in the interior space 32 of the entry tube 16, or if gas is detected in the atmosphere outside the entry tube 16, the control unit 36 is configured to shut off power to the inspection apparatus 10. This safety feature helps to ensure that the apparatus 10 will not operate in a potentially unsafe condition.

The control unit 36 may also include other features as well. For example, a video monitor 68 can be provided to allow an operator to view images from the interior 12 of the pipeline 14 during the inspection process. This real time monitoring maybe helpful in that it allows the operator to adjust the pan and/or tilt of the camera to capture images of specific areas within the pipeline interior 12. In addition, the control unit 36 may be equipped with a recording device, such as a digital storage device 70 to record digital image data from a CCD camera, or a video tape recorder 72 to record images when an analog camera is used.

As illustrated in FIG. 2, the control unit 36 has wheels 74 attached to a base 76 to make it easy to transport. Alternatively, the entire control unit 36 may be configured to fit within a single carrying case. Although the control unit may be configured with an internal power source, it is contemplated that the entire inspection apparatus will be run from an external AC power source. Of course, the control unit 36 may contain transformers or the like, so that it may provide, for example, the motors on the articulation mechanism 48 with DC current. By keeping the power source external, embodiments of the invention may provide portability such that the inspection apparatus is easily used by an operator in the field.

One such method of use includes having an operator attach the flange 18 of entry tube 16 to the flange 20 of the first valve 22 on the live gas pipeline 14 (see FIG. 1). The two flanges 18, 20 are sealed with gasket material, an O-ring or the like. The operator then opens the stopcock 30, such that the interior space 32 of the entry tube 16 is in fluid communication with the environment 35 surrounding the entry tube 16. The first valve 22 is then opened, and pressurized gas from the pipeline interior 12 enters the interior space 32 of the entry tube 16. Some of the gas then escapes to the environment 35 via the stopcock 30. When the operator detects the presence of the gas outside the entry tube 16—usually the smell of the gas will be an indicator-the stopcock 30 is closed, such that further release of gas is prohibited.

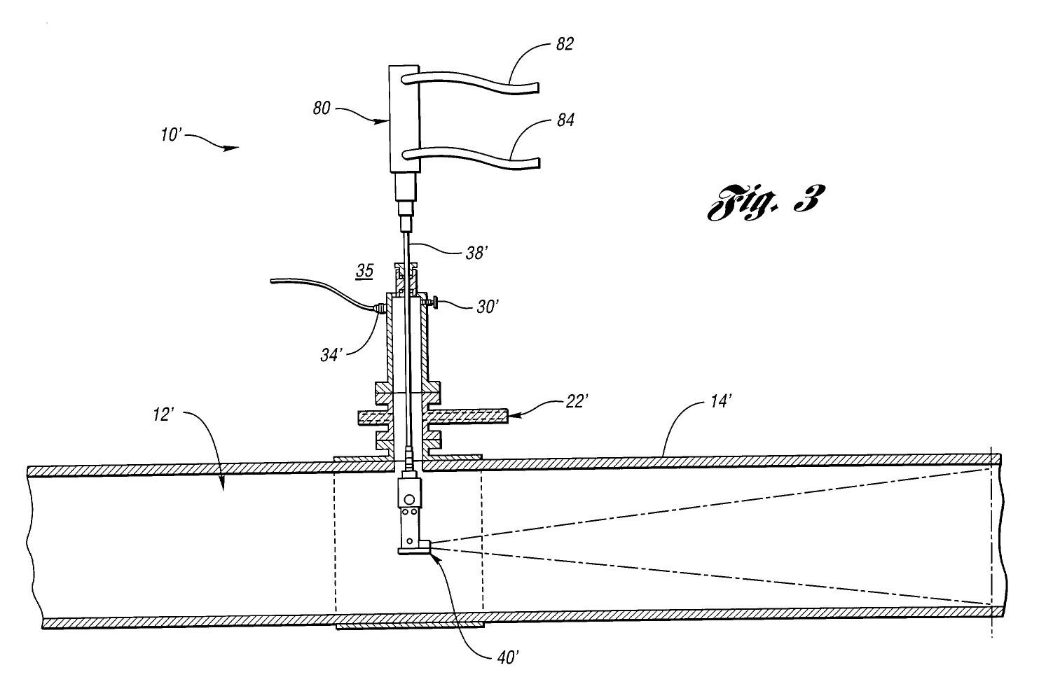

The operator next moves the first end 50 of the guide pole 38 into the pipeline interior 12 to position the camera module 40 for inspection. A site glass 78 is provided in the entry tube 16, such that the operator can view the location of the camera module 40 within the pipeline interior 12. An alternative to having the operator manually lower the camera module 40 into the pipeline interior 12 is to provide the guide pole 38 with a guide pole actuator 80 (see FIG. 3). The guide pole actuator 80 allows an operator to remotely lower a camera module, such as 40′ shown in FIG. 3, into a pipeline interior 12′. This may be important when inspecting high pressure lines, as the remote operation provides an additional safety measure for the operator.

The guide pole actuator may be any one of various types of linear actuators, though a telescoping device, such as a pneumatic or hydraulic cylinder, may be particularly well suited to this application. Since it is contemplated that the present invention may be used to inspect pipelines 48 inches or more in diameter, the guide pole may be six or more feet in length. Hence, a telescoping actuator helps to conserve space, by providing the necessary length of linear travel, while not doubling the length of the guide pole. The guide pole actuator 80, shown in FIG. 3, is a hydraulic actuator, having hydraulic hoses 82, 84 that attach to a pump (not shown). The pump is controlled by an electronic control unit such as 36 shown in FIG. 2, so that the operator can remotely position the camera module 40′ while viewing relayed image data on a monitor. The operator can then adjust the vertical position and the pan and tilt the camera module 40′ as needed to provide additional image data from the pipeline interior 12′.

By using the inspection apparatus as described above, an operator working in the field can safely inspect the interior of live gas mains, thereby obviating the need to decommission the main for the inspection. The recorded data can then be used to evaluate the best alternatives for rehabilitation strategy. Indeed, the results of the inspection may lead to a determination that rehabilitation is not required, in which case, the gas main will not have been unnecessarily taken out of service. The advantage in cost savings both to the utility and the gas consumer may be significant.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for inspecting a pressurized pipeline having an access structure attached thereto for selectively allowing access to an interior of the pipeline, the apparatus comprising:
an attachment structure, a portion of which defines an interior space, the attachment structure being configured for sealing attachment to the access structure of the pipeline;
a guide pole having a pole axis, and at least partially disposed within the interior space of the attachment structure and movable relative to the attachment structure;
a sealing mechanism for sealingly attaching the guide pole to the attachment structure;
an articulation mechanism attached to a first end of the guide pole;
a camera module attached to the articulation mechanism and configured to pass through the access structure and into the interior of the pipeline;
a light source configured to illuminate the interior of the pipeline; and
an electronic control unit for at least controlling the articulation mechanism and the camera module.

2. The apparatus of claim 1, wherein the attachment structure includes a tube having a flange at one end, the flange being configured for sealing attachment to a mating flange on the access structure of the pipeline.

3. The apparatus of claim 1, wherein the access structure is a first valve attached to at least a portion of a pipeline tapping mechanism, the first valve allowing selective fluid communication between the pipeline and the interior space of the attachment structure.

4. The apparatus of claim 1, wherein the attachment structure includes a site glass for viewing into the interior space of the attachment structure.

5. The apparatus of claim 1, wherein the attachment structure includes a second valve for releasing air from the interior space of the attachment structure to an environment surrounding the attachment structure.

6. The apparatus of claim 1, wherein the articulation mechanism is configured to selectively rotate the camera module about a first axis substantially parallel to the guide pole, and about a second axis forming an angle with the first axis.

7. The apparatus of claim 1, wherein the camera module includes an optical zoom feature controlled by the control unit.

8. The apparatus of claim 1, wherein the camera module includes a digital zoom feature controlled by the control unit.

9. The apparatus of claim 1, wherein the camera module includes an infra red light source, and the camera module is configured to capture infra red images.

10. The apparatus of claim 1, wherein the light source includes a fiber optic light and a collimating lens for focusing the light emitted from the fiber optic light.

11. The apparatus of claim 1, further comprising a guide pole actuator for moving the guide pole along the pole axis.

12. The apparatus of claim 1, further comprising a sensor attached to the attachment structure and connected to the control unit, the sensor being configured to sense pipeline gas in an environment surrounding the attachment structure and oxygen in the interior space of the attachment structure.

13. A method of inspecting a pressurized pipeline using the apparatus of claim 1, the method comprising:
boring a hole into the pipeline with a boring apparatus, the boring apparatus including a first valve for selectively allowing access to an interior of the pipeline;
sealingly attaching the attachment structure of the apparatus to the first valve;
opening the first valve;
moving the first end of the guide pole to a first position within the interior of the pipeline to position the camera module for inspection of the interior of the pipeline;
relaying image data from the camera module to an output apparatus; and
electronically manipulating the articulation mechanism to orient the camera module to provide additional image data from the interior of the pipeline.

14. A method of inspecting a pressurized pipeline using the apparatus of claim 1, the method comprising:
boring a hole into the pipeline with a boring apparatus, the boring apparatus including a first valve for selectively allowing access to an interior of the pipeline;
sealingly attaching the attachment structure of the apparatus to the first valve;
opening the first valve;
moving the first end of the guide pole to a first position within the interior of the pipeline to position the camera module for inspection of the interior of the pipeline;
relaying image data from the camera module to an output apparatus;
electronically manipulating the articulation mechanism to orient the camera module to provide additional image data from the interior of the pipeline; and
moving the first end of the guide pole to a next position to move the camera module to provide further image data from the interior of the pipeline.

15. A method of inspecting a pressurized pipeline using the apparatus of claim 1, the method comprising:
boring a hole into the pipeline with a boring apparatus, the boring apparatus including a first valve for selectively allowing access to an interior of the pipeline;
sealingly attaching the attachment structure of the apparatus to the first valve;
opening a second valve on the attachment structure, the second valve being configured to at least allow fluids to pass from the interior space of the attachment structure to an environment surrounding the attachment structure.
opening the first valve;
closing the second valve after gas from the pipeline passes through the second valve into the environment surrounding the attachment structure;
moving the first end of the guide pole through the first valve and into a first position within the interior of the pipeline to position the camera module for inspection of the interior of the pipeline;
relaying image data from the camera module to an output apparatus; and
electronically manipulating the articulation mechanism to orient the camera module to provide additional image data from the interior of the pipeline.
